(19) United States
(12) Patent Application Publication
(10) Pub. No.: US 2007/0055841 A1
(43) Pub. Date: Mar. 8, 2007

(54) Memory allocation in a computer system

(75) Inventors: Peter Gerardus Jansen, EINDHOVEN (NL); Bob Janssen, LAGE ZWALUWE (NL)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: REAL ENTERPRISE SOLUTIONS DEVELOPMENT B.V., 'S-HERTOGENBOSCH (NL)

(21) Appl. No.: 10/596,141

(22) PCT Filed: Dec. 16, 2003
(86) PCT No.: PCT/NL03/00896

§ 371 Date: Jun. 20, 2006

(51) Int. Cl. G06F 12/00

(52) U.S. Cl. 711/170

(57) ABSTRACT

A method of controlling memory allocation in a computer system (1) comprising physical memory (3), at least one storage device (7, 9, 10) and at least one processing unit (2) and arranged to implement virtual memory, which computer system is capable of enabling at least two processes associated with respective instances (14, 17) of application programs to be running, only one active process being enabled to receive input from a user at any one time, comprises selecting at least one of the processes to be at least partially transferred from physical memory (3) to a storage device (7, 9, 10). Processes are selected by monitoring which processes have been inactive for longer than a pre-determined time interval.

The invention relates to a method of controlling memory allocation in a computer system comprising physical memory, at least one storage device and at least one processing unit and arranged to implement virtual memory, which computer system is capable of enabling at least two processes associated with respective instances of application programs to be running, only one active process being enabled to receive input from a user at any one time, comprising selecting at least one of the processes to be at least partially transferred from physical memory to a storage device.

The invention further relates to a computer system, comprising physical memory, at least one storage device and at least one processing unit, and arranged to implement virtual memory, which computer system is capable of executing at least two processes associated with respective instances of application programs, and configured to enable only one active process to receive input from a user at any one time, wherein the computer system is configured to select at least one of the processes to be at least partially transferred from physical memory to a storage device.

The invention also relates to a computer program product.

Examples of a method, system and computer program of the types mentioned above are known. The known method makes use of the graphical user interface (GUI) provided to a user by the computer system. Each application program has at least one associated process which, either directly or by means of a thread of that process, ‘owns’ one or more windows displayed as part of the GUI. Whenever a user minimizes a window owned by a process (i.e. reduces it to an icon or button occupying only a small part of the displayable area), this serves as a trigger to swap out the associated process to a file on a hard disk drive, thus freeing up physical memory. The freed up physical memory becomes available to other processes. Minimizing of the window means the process swapped out is not likely to be busy in the near future, so page faults are prevented in this way. This pre-empts action by the computer system's operating system to free physical memory when all of it is used by paging out pages of all the running processes.

A problem of the known method is that it relies on the user actually minimizing a window when he has (temporarily) finished using the instance of the application program. However, most users leave the window ‘open’, so that the process is not transferred and continues to occupy part of the physical memory.

It is an object of the present invention to provide an improved method of controlling memory, computer system and computer program product, that enable more efficient use of physical memory.

This object is achieved by means of the method of the invention which is characterised in that processes are selected by monitoring which processes have been inactive for longer than a pre-determined time interval.

In the present context, a process refers to a container for a set of resources used to execute an instance of a program, including instructions comprised in the program and data referred to in those instructions. Physical memory comprises those memory devices used to store resources accessed by processes or threads of processes that are being executed by a processing unit. Virtual memory is a method of extending the amount of memory addressable by processes, by storing parts of processes in one or more files in memory provided in addition to the physical memory, such as a hard disk unit. Such files are commonly known as swap files or page files.

Because processes are selected by monitoring which processes have been active or inactive, the method does not rely on specific user actions to keep as much physical memory free as possible. Because the method is based on user interaction, it is biased towards processes which are not associated with applications to which the attention of the user is directed. Therefore, the user remains relatively unaware of the use of the method.

According to another aspect of the invention, the object is achieved by a method which is characterised by selecting a process after determining that more than a predetermined interval of time has elapsed since creation of the process.

This aspect of the invention is based on the recognition that, when an application program is started, i.e. one or more new processes associated with the new instance of that program are created, a large amount of physical memory is allocated to that process or those processes. Although this amount can be necessary to ensure smooth start-up of the program, it is generally not needed during execution. Conventionally the memory allocation is slowly decreased as pages are paged out by a memory manager when physical memory must be freed to accommodate further processes. By selecting a process automatically after determining that a pre-determined interval of time has elapsed since creation of the process, more physical memory is freed at an earlier stage.

Preferably, the method comprises comprising determining a respective share of processing capacity of at least one of the processing unit(s) dedicated to running each selected process, and initiating the at least partial transferral of only those selected processes of which the share lies below a pre-determined level.

Thus, processes which are selected because the user is not interacting with them are not paged out if these processes are nevertheless using a substantial part of the processing capacity available for running that process. Therefore, processes performing calculations for which user input is not immediately required are not transferred to a swap file or page file.

Preferably, the method comprises comprising determining a fraction of processing capacity of the processing unit(s) being used, and initiating transferral of one or more of the selected processes only if the fraction lies below a pre-determined maximum.

Thus, account is taken of the fact that paging or swapping out of processes is a processing-intensive process. In this embodiment, such transfer is initiated when there is spare capacity of the processing units available.

In a preferred embodiment, the step of selecting is carried out irrespective of how much of the physical memory is available for additional processes.

Thus, the invention is used to prevent physical memory becoming full. It may thus enhance mechanisms already present within a memory manager of an operating system of the computer system, which act when the physical memory is full, and remove pages belonging to one or more processes only then. At this stage, the operating system will hardly respond to user input. This embodiment of the invention helps to prevent such a stage from being reached.

Preferably, the step of selecting is repeatedly carried out.

Thus, a method is provided which acts continuously to keep as much physical memory available as possible, allowing more processes to be run concurrently on the same computer.

According to another aspect of the invention, the computer system is characterised in that the computer system is configured to select processes by monitoring which processes have been inactive for longer than a pre-determined time interval.

This computer system makes efficient use of its physical memory in a way that disrupts the use of the computer system by the user to a minimal extent.

According to a further aspect of the invention, the computer system is configured to select a process after determining that more than a pre-determined interval of time has elapsed since creation of the process.

Thus, more physical memory is freed at an earlier stage after a user starts up a new instance of an application program.

According to a further aspect of the invention, there is provided a computer program having thereon means, when run on a computer system, for enabling the computer system to carry out a method according to the invention.

The invention will now be explained in further detail with reference to the accompanying drawings, in which

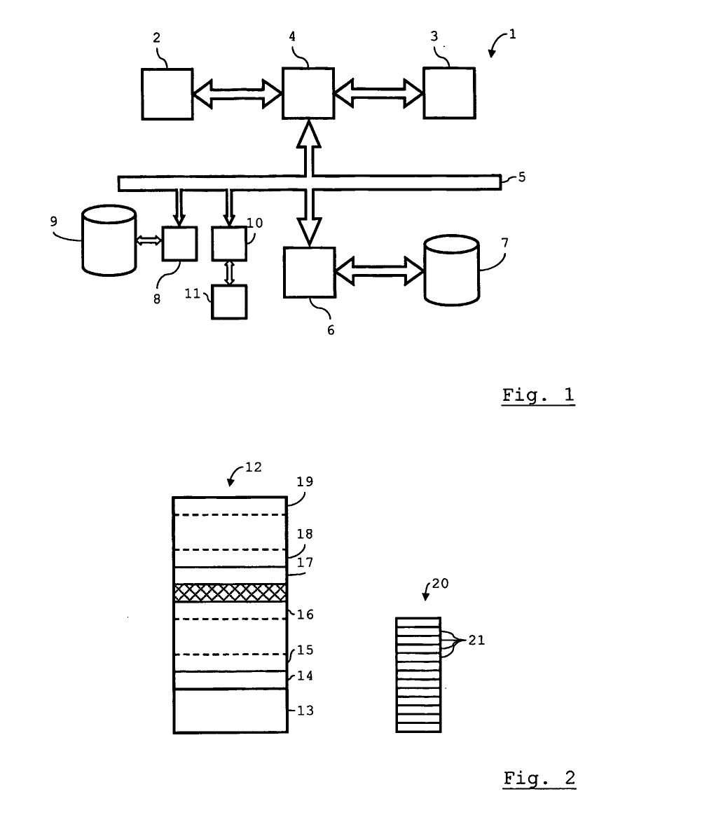

FIG. 1 shows schematically selected components of a computer system;

FIG. 2 shows schematically the allocation of virtual memory space to two processes; and

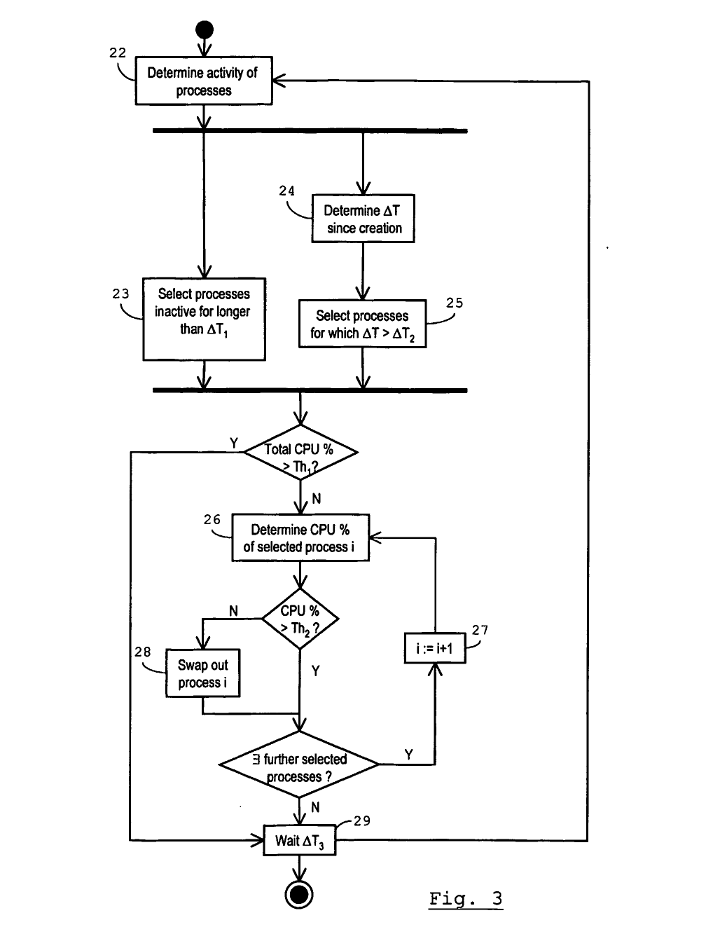

FIG. 3 is a flow chart illustrating a method of controlling memory allocation.

In FIG. 1, a computer system 1 comprises a central processing unit (CPU) 2, system memory 3 and a bridge chip 4. The bridge chip 4 connects the CPU 2 to the system memory 3 and to an EIDE disk controller 5 via a main bus 6. The system memory 3 preferably comprises random access memory (RAM). The main bus can, for example be arranged to conform to the Peripheral Component Interconnect (PCI) standard, or PCI-X standard. Other variants are possible, depending on the type of computer system.

In FIG. 1 a single processor system is shown by way of example. The invention may, however, also find use in a dual or multi-processor system.

Although a single device is detailed in FIG. 1, the invention is in particular also suited to use in a client-server computer system, in which applications are (mainly) run on a server and terminals are provided to one or more users for interacting with those application. On such systems, each user has his own session with his own allocation of virtual memory, comprising a share of physical memory and one or more page files on a storage device of the server or client terminal. The method described herein is used to make as efficient use of the allocated share of physical memory as possible.

Returning to the illustrated example, the EIDE disk controller 6 is used to control an EIDE hard disk unit (EIDE HDU) 7. Of course, there may be several of such EIDE HDUs 7. Although a multitude of devices will in practice be connected to the main bus 5, for the present purposes, it suffices to illustrate a small components serial interface (SCSI) controller 8, controlling a SCSI HDU 9 and a Universal Serial Bus (USB) controller 10, controlling a flash memory module 12, which may be removable.

The computer system 1 is configured to implement virtual memory. This term denotes a method for increasing the range of memory addressable by processes in execution on the computer system. In such a method processes are partially or completely stored in one or more files in memory provided in addition to the system memory 4, such as in the EIDE HDU 7, the SCSI HDU 9, or flash memory module 11. The basic principle is illustrated in FIG. 2.

In this example, two processes associated with respective instances of application programs are running. Virtual memory space 12 is occupied by an operating system 13, first program instructions 14, first process data 15, a first process stack 16, second program instructions 17, second process data 18 and a second process stack 19. The virtual memory space 12 is much larger than physical memory space 20. A page map is used by a memory manager in the operating system 13, to map pages belonging to processes occupying the virtual memory space 12 to pages 21 in physical memory space 20, or to page files (not shown), maintained on one or more of the EIDE HDU 7, SCSI HDU 9 or flash memory module 11.

Commonly used operating systems, such as those belonging to the Microsoft Windows family, comprise a memory manager that implements a policy for deciding whether pages of a certain process are maintained in the system memory 3, or in a swap file on a storage device such as EIDE HDU 7. Two of these may be used alongside the method presented herein.

A first is used when the system memory 3 is full, i.e. when pages in virtual memory space 12 are mapped to the entire physical memory space 20, and more physical memory space is needed. This would occur where a thread being executed on the CPU 2 addresses a data in a page that is mapped to a page file. In that case, space must be made available in the system memory 3. The operating system 13 takes away pages in the physical memory space 20 from each of the processes. It is noted that the method disclosed in the present application aids in preventing this situation from occurring, by virtue of the fact that it is carried out irrespective of how much of the physical memory space 20 is still available for additional processes. It is not desirable to rely only on removal of pages from physical memory when the physical memory space has been completely allocated, since the computer system becomes noticeably slower some time before this point is reached. Furthermore, paging out—which is a processing-intensive activity—would then have to be carried out when running processes are also placing demands on the capacity of the CPU 2.

A second known policy is based on a user's use of the Graphical User Interface. Each instance of an application program running on the computer system 1 will have one or more windows, owned by threads of execution of the process associated with that instance. The process of which the thread owns the foreground window is said to have the focus. In the terms of the present application, this process is active, in the sense that the operating system has enabled this process to receive input from the user at that point in time (through the use of a mouse, keyboard, or other input device). None of the other processes is active at that point. The second known policy is to transfer the pages of a process when the user has minimized the window or windows owned by that process. This known policy is usable alongside the method disclosed herein, but rarely results in paging out of processes, as most users do not minimize windows when they have temporarily finished with one instance of a program. Most users simply switch to another window.

Turning to FIG. 3, an embodiment of a supplementary method is illustrated. This method enhances the memory management functions of the operating system and is independent of the operating system 13. Thus, it can be implemented as middleware, i.e. a separate application running in user space. It may, however, also be implemented in a memory manager of the operating system 13. In brief, computer program code, comprised in the operating system 13 or in a separate program, may be used to configure the computer system 1 to carry out the method described herein. The computer system 1 running this program code thus comprises means for performing the various functions described in the present application.

In a first step 22, the active one of the processes associated with the respective instances of application programs that are running is determined. Only one process can be active, i.e. be enabled by the operating system to receive any input the user may provide through mouse, keyboard, trackball, voice control, etc. Where the computer system 1 has a graphical user interface, this process is the process of which one of the threads of execution owns the foreground window, i.e. the process that has the focus. The step 22 advantageously makes use of function calls provided by an application program interface (API) of the operating system, which return the required information.

In a subsequent step, a selection is made of processes that are candidates for paging out. In the shown embodiment, this selection step comprises sub-steps comprised in two parallel branches of the method. It is noted that embodiments of the invention are possible in which one of these branches are omitted. However, the combination has certain advantages. By combining the two selection mechanisms, one set of selected processes results. Thus, paging out of processes which are selected in both branches is initiated only once. This is an advantage because the process of paging out is CPU-intensive.

In one step 23, those processes of the processes associated with respective instances of running application programs are selected that have been inactive for longer than a pre-determined time interval ΔT₁. To this end, the process that has the focus is recorded each time the previous step 22 is carried out. Thus a record of which process has the focus at which point in time is established. Using this record, it is possible to determine the interval of time for which each process that does not have the focus has been inactive.

In a parallel branch, it is first determined for each process how much time has elapsed since that process was created. When that time interval first exceeds a predetermined time interval ΔT₂, the process is selected. It is noted that this is done regardless of whether the process is active or how long the process has been inactive. Thus, a process that has recently been the active process may still be paged out, if it has also just been created. If it becomes active again soon after having been partially or completely transferred to a page file, it will be paged in again by the operating system. However, the operating system is configured to allocate a process a much larger amount of the physical memory space 20 upon its creation than upon its subsequent paging in. Thus, these steps 24,25 aid in freeing physical memory space, which might otherwise go unused, and is not necessarily freed if only the parallel step 21 is carried out.

In principle, the partial or complete transfer of the selected processes from system memory 4 could now be carried out. However, in the preferred embodiment shown in FIG. 3, this is made conditional upon the total fraction of processing capacity of the CPU 2 currently being used. Only if this fraction lies below a pre-determined maximum can paging out be initiated. This is done to prevent the process of paging out from using up too much processing capacity at a time when it is needed for processes associated with application programs. Thus, the user is left largely unaware of the execution of the method.

Because some processes associated with running instances of application programs may in fact be executing without user input, the shown embodiment proceeds to a subsequent step 26, which is repeated (step 27) for each selected process. In this step 26, the respective share of processing capacity of at least of the processing unit(s) dedicated to running the selected process concerned is determined. This may be done using a function call provided by an API of the operating system. Where a single CPU 2 is provided in the computer system 1, this share is simply the fraction of processing capacity of the CPU 2 that is being used by threads of execution of the process. In a multiprocessor system, the share would be the share of the total processing capacity available for executing threads of execution of the process concerned. Depending on the operating system, this corresponds to the share of the total processing capacity of the computer system, or to the share of the processing capacity provided by the sub-set of processing units made available for executing threads of execution of the process concerned.

Only if the share lies below a pre-determined level Th₂, is complete or partial removal of the process concerned from the physical memory space initiated in a step 28. It is noted that, in an implementation of the method in a program running on top of the operating system, this initiation step 28 would comprise an appropriate function call to the operating system, which would react accordingly to carry out the actual transferral. Thus the method disclosed herein may comprise only the initiation of such transferral but not the actual transferral itself.

In order to keep as much space free in physical memory as possible, the present method is repeated carried out, for example at regular intervals ΔT₃. Thus, after the loop comprising steps 26-28 has been run through for the last of the selected processes, the method returns to the first step 22, by way of a waiting step 29. After the time intervals since creation have been determined in step 24, only those processes are selected in step 25 for which it is determined for a first time since creation of the process that more than the pre-determined interval of time ΔT₂ has elapsed.

It will be apparent to those skilled in the art that the invention is not limited to the above-described embodiments, which may be varied in a number of ways within the scope of the accompanying claims. In particular, the physical memory may comprise a plurality of separated discrete memory modules or devices accessible by the or each processing unit.

1. Method of controlling memory allocation in a computer system (1) comprising physical memory (3), at least one storage device (7,9,10) and at least one processing unit (2) and arranged to implement virtual memory, which computer system is capable of enabling at least two processes associated with respective instances (14,17) of application programs to be running, only one active process being enabled to receive input from a user at any one time, comprising selecting at least one of the processes to be at least partially transferred from physical memory (3) to a storage device (7,9,10), characterised in that processes are selected by monitoring which processes have been inactive for longer than a pre-determined time interval (ΔT₁).

2. Method according to the pre-amble of claim 1, characterised by selecting a process after determining that more than a pre-determined interval of time (ΔT₂) has elapsed since creation of the process.

3. Method according to claim 1 or 2, comprising determining a respective share of processing capacity of at least one of the processing unit(s) (2) dedicated to running each selected process, and initiating the at least partial transferral of only those selected processes of which the share lies below a pre-determined level (Th₂).

4. Method according to any one of claims 1-3, comprising determining a fraction of processing capacity of the processing unit(s) (2) being used, and initiating transferral of one or more of the selected processes only if the fraction lies below a pre-determined maximum (Th₁).

5. Method according to any one of the preceding claims, wherein the step of selecting is carried out irrespective of how much of the physical memory (3) is available for additional processes.

6. Method according to claim 5, wherein the step of selecting is repeatedly carried out.

7. Computer system, comprising physical memory (3), at least one storage device (7,9,11) and at least one processing unit (2), and arranged to implement virtual memory, which computer system is capable of executing at least two processes associated with respective instances of application programs (14,17), and configured to enable only one active process to receive input from a user at any one time, wherein the computer system is configured to select at least one of the processes to be at least partially transferred from physical memory to a storage device, characterised in that the computer system is configured to select processes by monitoring which processes have been inactive for longer than a pre-determined time interval (ΔT₁).

8. Computer system according to the pre-amble of claim 7, characterised in that the computer system is configured to select a process after determining that more than a pre-determined interval of time (ΔT₂) has elapsed since creation of the process.

9. Computer program product, having thereon means, when run on a computer system (1), for enabling the computer system to carry out a method according to any one of claims 1-6.
